(19) United States
(12) Patent Application Publication
(10) Pub. No.: US 2018/0013556 A1
(43) Pub. Date: Jan. 11, 2018

(54) SYSTEM, APPARATUS AND METHOD FOR ENCRYPTING OVERLAY NETWORKS USING QUANTUM KEY DISTRIBUTION

(71) Applicant: TELOIP INC., Mississauga (CA)

(72) Inventor: Patricio Humberto SAAVEDRA, Toronto (CA)

(21) Appl. No.: 15/635,929

(22) Filed: Jun. 28, 2017

Related U.S. Application Data
(60) Provisional application No. 62/358,962, filed on Jul. 6, 2016.

(51) Int. Cl. H04L 9/08; H04B 10/70; H04B 10/85; H04L 29/06

(52) U.S. Cl. CPC H04L 9/0852; H04L 63/10; H04B 10/70; H04B 10/85; H04L 67/42

(57) ABSTRACT

A network system is provided for improving network communication performance between a first client site and a second client site, the network system including: at least one client site network component bonding or aggregating one or more diverse network connections; and at least one network server component, configured to interoperate with the client site network component, the network server component including a server/concentrator that is implemented at an access point to a high performing network, between the client site network component and the network server component data traffic is carried to a network backbone of the high performing network, while maintaining management of data traffic so as to provide a managed network path that incorporates both at least the bonded/aggregated connection and at least one network path carried over the high performing network. The system uses quantum key distribution to encrypt the managed network path.

### FIELD

The present disclosure relates generally to network communications and, in particular, to encrypting communications links in a variety of different networks including wired and wireless networks, and including Wide Area Networks (“WAN”).

### BACKGROUND

While the capacity of network connections has increased since the introduction of dial up, high speed connectivity is not ubiquitous in all regions. Also, bandwidth is not an unlimited resource and there is a need for solutions that improve the utilization bandwidth and also that address network performance issues.

Various solutions exist for improving network performance such as load balancing, bonding of links to increase throughput, as well as aggregation of links. In regards to bonding/aggregation various different technologies exist that allow two or more diverse links (which in this disclosure refers to links associated with different types of networks and/or different network carriers) are associated with one another for carrying network traffic (such as a set of packets) across such associated links to improve network performance in relation for such packets.

Examples of such technologies include load balancing, WAN optimization, or ANA™ technology of TELoIP™, as well as WAN aggregation technologies.

Many of such technologies for improving network performance are used to increase network performance between two or more locations (for example Location A, Location B, Location N or the “Locations”), where bonding/aggregation of links is provided at one or more of such locations. While the bonded/aggregated links provide significant network performance improvement over the connections available to carry network traffic for example from Location A to an access point to the backbone of a network (whether an Internet access point, or access point to another data network such as a private data network or high performance wireless network) (“network backbone”), the bonded/aggregated links are generally slower than the network backbone.

Prior art technologies including bonding/aggregation generally result in what is often referred to as “long haul” bonding/aggregation, which means that the bonded/aggregated links are maintained for example from Location A and Location B, including across the network backbone, which in many cases results in network impedance. As a result, while bonding/aggregation provides improved network performance for example from Location A to the network backbone, network performance across the entire network path for example from Location A to Location B, may be less than optimal because the technology in this case does not take full advantage of the network performance of the network backbone.

There is a need for a system and method that addresses at least some of these problems.

### SUMMARY

In accordance with some embodiments, there is provided a network system for improving network communication performance between a first client site and a second client site. The system may include: (a) at least one client site network component that is implemented at the first client site, the client site network component bonding or aggregating one or more diverse network connections so as to configure a bonded/aggregated connection that has increased throughput; and (b) at least one network server component, configured to interoperate with the client site network component, the network server component including a server/concentrator that is implemented at an access point to a high performing network, wherein the client site network component and the network server component are configured to interoperate so as to create and maintain a network overlay for managing network communications between the first client site and the access point, wherein between the client site network component and the network server component data traffic is carried over the bonded/aggregated connection and between the access point and the second client site the network server component automatically terminates the bonded/aggregated connection and passes the data traffic to a network backbone of the high performing network, while maintaining management of data traffic so as to provide a managed network path that incorporates both at least the bonded/aggregated connection and at least one network path carried over the high performing network. A quantum key distribution is used to encrypt the managed network path.

In an aspect, the system may include a quantum layer configured to distribute at least one quantum key to encrypt the managed network path.

In another aspect, the system may include a quantum key distribution manager device operable to detect a security breach in the quantum layer, and upon the detection of the security breach, operable to provide and distribute a new secure key.

In some embodiments, the system includes a quantum layer configured to distribute at least one quantum key to encrypt the managed network path.

In some embodiments, the quantum layer is implemented at a physical network layer.

In some embodiments, the quantum layer is implemented using entangled photon delivery.

In some embodiments, the quantum layer is implemented using a passive fiber network.

In some embodiments, the quantum layer implements entangled photon integrity limits for delivery of entangled photon from a quantum key distribution device.

In some embodiments, a quantum key distribution manager device is operable to detect a security breach in the quantum layer, and upon the detection of the security breach, operable to provide and distribute a new secure key.

In some embodiments, a Centralized Orchestrator configured to securely distribute Quantum Keys to a dependent chain of devices.

In some embodiments, the dependent chain of devices can be groups of client site network components and network server components configured to use per customer keys for encryption in an underlay network to protect the network overlay to form a customer protected route domain.

In some embodiments, quantum key distribution can encrypt communication between a sender device and a receiver device by creating a key and sending weak optical pulses over a quantum channel, wherein the key enables the devices to communicate over a public channel by using the exchanged key to encrypt messages.

In another aspect, there is provided a network system for improving network communication performance between a first client site and a second client site. The system has at least one client site network component that is implemented at the first client site, the client site network component bonding or aggregating one or more diverse network connections so as to configure a bonded/aggregated connection that has increased throughput, and at least one network server component, configured to interoperate with the client site network component, the network server component including a server/concentrator that is implemented at an access point to a high performing network. Between the client site network component and the network server component data traffic is carried over the bonded/aggregated connection and between the access point and the second client site the network server component automatically terminates the bonded/aggregated connection and passes the data traffic to a network backbone of the high performing network, and wherein the system uses quantum key distribution to encrypt the managed network path.

In some embodiments, a quantum layer configured to distribute at least one quantum key to encrypt the managed network path.

In some embodiments, a quantum layer is implemented at a physical network layer.

In some embodiments, a quantum layer is implemented using entangled photon delivery.

In some embodiments, a quantum layer is implemented using a passive fiber network.

In some embodiments, a quantum layer implements entangled photon integrity limits for delivery of entangled photon from a quantum key distribution device.

In some embodiments, a quantum key distribution manager device operable to detect a security breach in the quantum layer, and upon the detection of the security breach, operable to provide and distribute a new secure key.

In some embodiments, a Centralized Orchestrator configured to securely distribute Quantum Keys to a dependent chain of devices.

In some embodiments, the dependent chain of devices can be groups of client site network components and network server components configured to use per customer keys for encryption in an underlay network to protect the network overlay to form a customer protected route domain.

In some embodiments, the quantum key distribution can encrypt communication between a sender device and a receiver device by creating a key and sending weak optical pulses over a quantum channel, wherein the key enables the devices to communicate over a public channel by using the exchanged key to encrypt messages.

### BRIEF DESCRIPTION OF THE DRAWINGS

Examples of embodiments of the disclosure will now be described in greater detail with reference to the accompanying drawings, in which:

FIG. 1a illustrates a prior art network configuration that includes a bonded/aggregated network connection. FIG. 1a illustrates the problem of long haul aggregation/bonding.

FIG. 1b also illustrates a prior art network configuration that includes central management of bonded/aggregated network connections.

FIG. 2a shows a network solution in accordance with some example embodiments, with bonding/aggregation implemented at both Site A and Site B, while minimizing long haul effects based on the technology of the present disclosure.

FIG. 2b shows another network solution in accordance with some example embodiments, in which bonded/aggregated network service exists at Site A but not at Site B.

FIG. 2c shows a still other network solution in accordance with some example embodiments, in which bonding/aggregation is implemented as between Site A, Site B, and Site C.

FIG. 2d shows a further implementation of the network architecture that implements a plurality of servers/concentrators as part of a Point-of-Presence.

FIG. 3 is a block diagram of a communication device in accordance with some example embodiments, demonstrating the device as an aggregation means on the client/CPE side of a network connection.

FIG. 4 is a block diagram of a communication device in accordance with some example embodiments, demonstrating the device as an aggregation means on the server/concentrator side of a network connection.

FIG. 5 is a block diagram of a communication network in accordance with some example embodiments, demonstrating the device as an aggregation means on both the client/CPE side and server/concentrator side of a network connection.

FIG. 6 is a flow diagram of a method of providing redundancy and increased throughput through a plurality of network connections in an aggregated network connection.

FIG. 7a illustrates a prior art network architecture where long haul effects apply, and presents network performance based on download speed.

FIG. 7b illustrates improved network performance based on faster download speed in similar network conditions as in FIG. 7a but implemented in accordance with some example embodiments in order to reduce long haul bonding/aggregation.

FIG. 8 illustrates a WAN network diagram.

FIG. 9 illustrates a diagram of Software-Defined Network between switches.

FIG. 10 illustrates a diagram of Software-Defined Network between switches with overlays.

FIG. 11 illustrates a diagram of Software-Defined Wide Area Network with overlay networking.

FIG. 12 illustrates an infrastructure table for Software-Defined Wide Area Network secure overlay framework.

FIG. 13 illustrates a framework for securing network overlays with Quantum Key Distribution.

FIG. 14 illustrates an example embodiment of Quantum key distribution implementation for a Software-Defined Wide Area Network with overlay.

FIG. 15 illustrates a concept diagram of quantum layer and Quantum key distribution device.

FIG. 16 illustrates a network diagram implementing a quantum layer and Quantum key distribution.

### DETAILED DESCRIPTION

In an aspect, embodiments described herein provide a system, network architecture and networking method.

In some embodiments, a network solution is provided for improving network communication performance between at least two sites, where the two sites are at a distance from one another that is such that would usually require long haul network communication. The network solutions includes at least one network bonding/aggregation system that includes (A) at least one first network component that is implemented at a first service site, the first network component being configured to bond or aggregate one or more diverse network connections so as to configure a bonded/aggregated connection that has increased throughput; and (B) a second network component, configured to interoperate with the first network component, the second network component including a server/concentrator (also referred to as network server component) that is implemented at an access point to a high performing network backbone.

In one aspect, the first network component may be implemented using what is called in this disclosure a “CPE” or customer premises equipment (also referred to as client site network component). The CPE and a server/concentrator component (more fully described below) interoperate to configure the bonded/aggregated connections in order to provide improve network connections at a site associated with the CPE.

In some embodiments, the server/concentrator is implemented at an access point, with access to the network backbone so as to avoid long-haul bonded/aggregated network communications. As set out in the Example in Operation cited below, network architectures that involve long-haul bonded/aggregated network communication result in less than optimal performance, thereby minimizing the advantages of the bonding/aggregation technology. In other words, while the bonding/aggregation technology may improve service to Site A associated with for example a CPE (or equivalent), based on bonding/aggregation between the CPE and an associated server/concentrator (or equivalent), overall performance may be less than desired and in fact may be less than what would be available without bonding/aggregation because of the long haul effects of carrying the bonded/aggregated from Site A, to at least Site B. These long haul effects will present wherever Site A and at least Site B are at a substantial distance from one another.

The Example in Operation below illustrates the decrease in performance that results from the long haul effects.

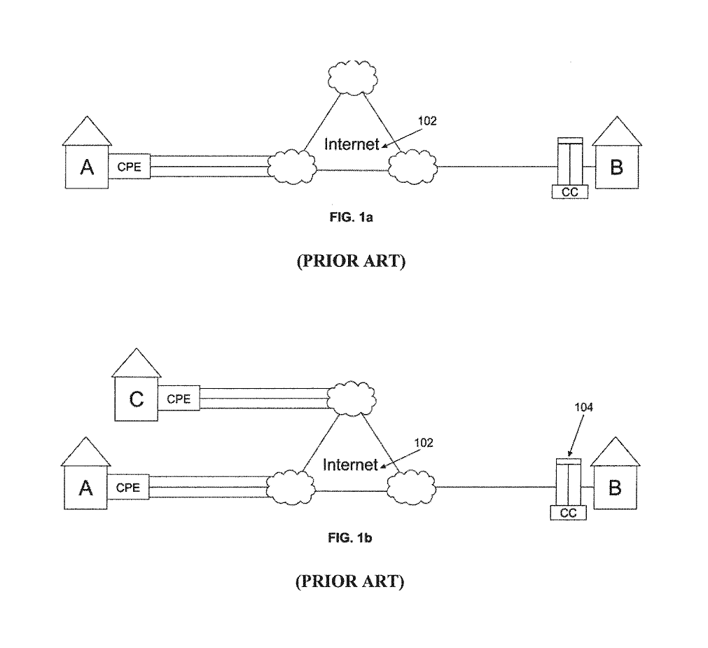

FIG. 1a illustrates the problem of long haul aggregation/bonding generally. In the prior art bonded/aggregated network communication shown in FIG. 1a, packets are carried over the Internet through an extension of the bonded/aggregated connection across the Internet (102), rather than the high performing Internet. The bonded/aggregated connection, across a distance that is subject to long haul effects, will not perform as well as the Internet, thereby providing less than ideal performance.

The Example in Operation reflects another problem with prior art bonding/aggregation solutions, namely that they generally require control or management by a central server. Depending on the location of the central server, this can result in multiplying of the long haul effects because traffic between a Site A and Site B may need to also be transferred to a Site C that is associated with the central server. This aspect of this example embodiment is illustrated for example in FIG. 1b. Central server (104) manages network communications, and in fact routes network communications between Site A and Site C. To the extent that the distance between central server (104) is substantial from either of Site A or Site C, long haul effects will present. If central server (104) is at a substantial distance from each of Site A and Site C, then there will be a multiplying of the long haul effects, as network traffic will pass from Site A to the central server (104) to Site C, and from Site C to the central server (104) to Site A.

As illustrated in the Example of Operation, long haul effects have a negative impact on speed (slowing traffic) and also on latency. Conversely, the present disclosure provides significant improvements in regards to both speed and latency.

The present disclosure provides a novel and innovative network solution, including a networking system and architecture and associated networking method that addresses the aforesaid long haul effects that have a negative effect on performance.

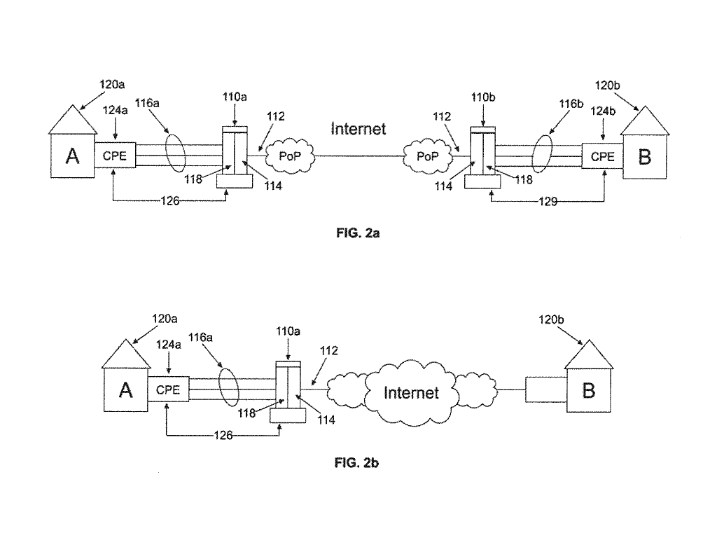

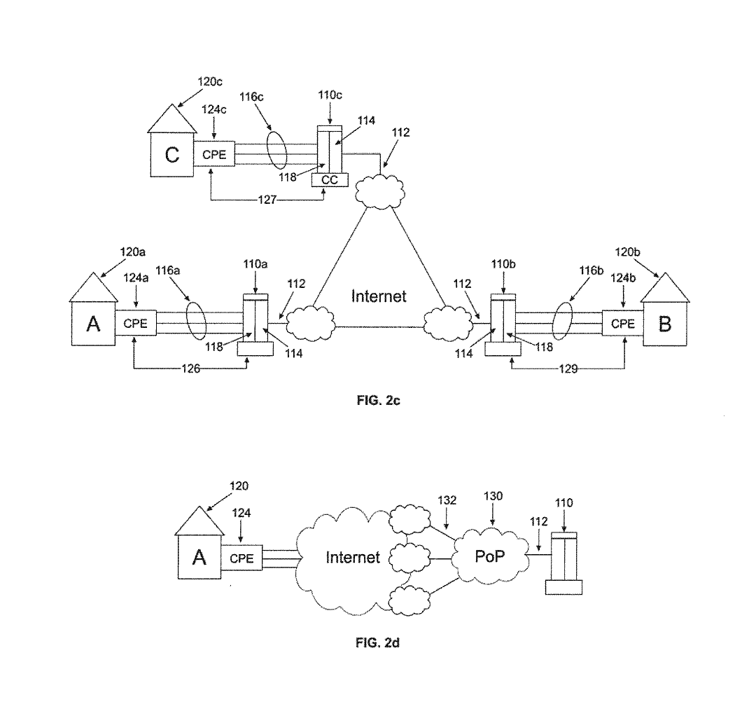

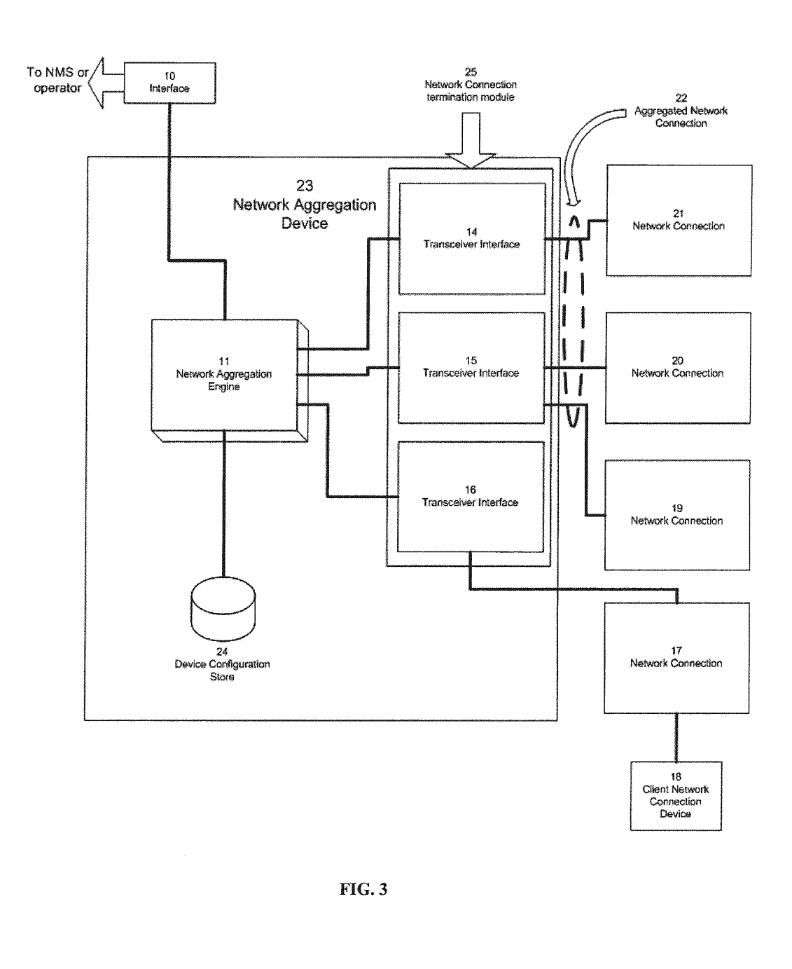

As shown in FIG. 2a, in one aspect of an example embodiment, the server/concentrator side of a bonding/aggregation network solution for Site A (120a) is implemented such that (A) the location of the server/concentrator is implemented with access to the network backbone of Internet (112), and (B) the server/concentrator (110a) includes functionality for (i) receiving packets by means of the bonded/aggregated connection (116a), (ii) interrupting the bonded/aggregated connection (116a) using an interruptor (118), and (iii) directing the packets (114) to the Internet (112) for delivery to a Site B (120b). If Site B also has bonded/aggregated network service, then the packets are delivered to a Site B side server/concentrator (110b). Server/concentrator (110b) established a further bonded/aggregated connection (116b) and directs the packets (114) via the bonded/aggregated connection (116b) to a CPE(B) (124b) at Site B.

FIG. 2b illustrates a configuration where bonded/aggregated network service exists at Site A but not at Site B.

In some embodiments, there may be more than two sites are possible, where the network system of the present disclosure improves network performance for network communications between for example Site A, Site B, and Site C where one or more sites will include bonded/aggregated service. In one implementation of an embodiment, as shown in FIG. 2c, bonded/aggregated service is present for each of Site A, Site B and Site C. FIG. 2c illustrates one possible implementation of an embodiment, where the network system is based on a distributed network architecture where server/concentrators (110a) (110b) (110c) and corresponding CPEs (124a) (124b) (124c) are configured to provide improved network communications, including interruption of network communications at the network backbone so as to reduce long haul effects, dynamically and on a peer to peer basis without the need for a persistent central manager. In one implementation, each of the network components of the network system included functionality to operate on a peer to peer basis.

A CPE (124) initiates network communications on a bonded/aggregated basis, cooperating with a server/concentrator (110), with packets destined for a remote location. Each server/concentrator (110) receives dynamic updates including a location and identifier associated with other server/concentrators (110). Packets are dynamically sent to a server/concentrator (110) at the remote location, if available, and from the server/concentrator (110) at the remote location to its CPE (124). The CPEs (124) and their server/concentrators (110) use bi-directional control of network communications to establish a network overlay to provide improved network performance. The network overlay for example provides desirable quality of service despite underlying network conditions that may otherwise resulted in a decrease in network performance.

In accordance with the some embodiments, the network system establishes and manages two or more network overlays. Referring for example to FIG. 2a a first network overlay (126) is established between the CPE(A) (124a) and server/concentrator (110a); then, communications are transferred over the Internet (112) without a network overlay; then, a second network overlay (129) is established between server/concentrator (110b) and CPE(B) (124b). As a result, IP transport is provided between Site A and Site B where this will provide better performance than the aggregated/bonded network connections. Bonding/aggregation in effect is distributed across the locations, rather than attempting to span the distance between the locations with end to end bonding/aggregation.

The present disclosure therefore provides distributed bonding/aggregation. The present disclosure also provides a network system that automatically provides distributed bonding/aggregation in a way that bonding/aggregation is proximal, and beyond proximal connections IP transport is used, with proximal bonded/aggregated connections and fast Internet being used as part of end-to-end improved service.

In another aspect of an embodiment, and as shown in FIG. 2d, one or more server/concentrators can be implemented at a physical location, as part of a Point-of Presence (PoP) (130). In one aspect, in the context of this embodiment, a PoP (130) can define a relatively high concentration of servers/concentrators within an area. In another aspect, a plurality of PoPs (130) may be available in a geographic location. A plurality of PoPs (130) may be established based on network topology or service requirements in a given area.

In one aspect, each PoP (130) has one or more network backbone connections (132), because in some locations different network backbones may be available. The PoP (130) may be implemented so that it dynamically interoperates with surrounding networks. The PoP (130) is a collection of network components, established at the periphery of the network backbone (112), associated with a plurality of networks, and cumulatively providing network communication service to one or more clients in a defined geographic area. In one possible implementation, the server/concentrators (110) located within the PoP (130) functions as a network access server for connecting to the Internet (112). The network access server (110) acts as the access point to the Internet (112) for a plurality of CPE devices (124) that are connected to the PoP (130). The servers/concentrators (110) may be configured to communicate with one another to share information regarding network conditions. Servers/concentrators (110) provide connectivity to CPEs (124) and may also run a networking protocol such as BGP to route servers and other network backbone connections (112).

In one aspect, servers/concentrators (110) are configured to detect changes in their network environment.

The CPE (124) may be configured to collect information from network components in its vicinity including from one or more available PoPs (130) and their servers/concentrators (110). The CPE (124) for example connects to a closest available server/concentrator (124), implemented as part of a PoP (130), and thereby having access to a connection to the network backbone (112). Whether the connection to the network backbone (112) is direct or indirect, the network connections are established so as to minimize long haul effects.

In one implementation, each CPE (124) wanting to establish a connection dynamically advertises its IP address, and receives replies from associated servers/concentrators (110) along with their current network performance information. The CPE (124) initiates a bonded/aggregated connection with a server/concentrator (110) that is both proximal (to minimize long haul effects between the CPE (124) to the network backbone (112)), and also that based on network conditions relevant to the particular server/concentrator, is performing well.

In one implementation, a network device is deployed that bonds or aggregate multiple, diverse links. The network device may be WAN aggregator or a link aggregator.

Once the network overlay is established, various other network optimization and quality of services (“QOS”) techniques may be applied.

One or more CPEs and one or more concentrators can create various different network configurations that improve network performance in relation to network communications between them. The CPEs and concentrators are designed to be self-configuring, and to interoperate with one another to manage traffic in a more effective way.

“Proximal” means a distance such that based on relevant network conditions, long haul network communication and associated effects are avoided. The distance between the CPE and the server/concentrator is proximal, thereby enabling good network service.

In some embodiments, in order to take advantage of the network architecture of the present disclosure, the server/concentrator (110) should be located at an access point to the network backbone (112) or in some other way to minimize the long haul effect, for example, by the server/concentrator being located proximal to an access point so as to further avoid long haul network communication.

In another aspect, the bonded/aggregated connection at Site A and the bonded/aggregated connection at Site B may be different, in the sense that each may include different types of network connections and that may be associated with different carriers. In one aspect of an embodiment, the network overlay provided operates notwithstanding such diversity.

The more sites that have the CPE/concentrators associated with them the better network performance between them. Representative performance details are included below.

The network backbone (112) could be any high performance network including for example a private WAN, the Internet, or an MPLS network.

### Network Overlay

In one aspect of an embodiment, one or more network overlays are established, thereby in one aspect providing a multi-POP network that exploits multiple points of presence so as to provide a persistent, configurable/reconfigurable network configuration that provides substantial network performance improvements over prior art methods.

In one aspect of an embodiment, the CPEs/concentrators may monitor network performance, including in the areas proximate to their position, and may reconfigure the network overlay dynamically, across multiple locations (including multiple PoPs) based on changes in network performance while providing continuity of service.

In one aspect, the network components may be intelligent, and iteratively collect network performance information. Significantly, in one aspect each CPE is able to direct associated concentrator(s) and any CPE to in aggregate re-configure the network overlay.

Significantly, in the network overlay created by an embodiment management of the network may be centralized or decentralized, depending on the configuration that provides the best overall performance. This is in contrast to prior art solutions that generally require central management for example of termination of connection which results in traffic being carrier over bonded/aggregated connection that involve long haul transmission that fail to take advantage of network paths that may provide inherently better performance than the bonded/aggregated connection paths.

In one aspect, decentralized managed is made possible by peer-to-peer functionality implemented to the network components of an embodiment.

In another aspect of an embodiment, a plurality of servers/concentrators may be established in multiple locations covering a plurality of different access points. Each server/concentrator may be used for multiple clients associated with different CPEs to improve network performance for such multiple clients by providing termination of their bonded/aggregated connection and transfer of communications to the network backbone. The network solution of an embodiment therefore may include multiple Points-of-Presence, distributed geographically including for example in areas requiring network service, and through the network architecture of an embodiment bridging geographically disparate areas with improved network communication therebetween.

### Additional Implementation Detail

As previously stated, an embodiment may be implemented in connection with any technology for bonding or aggregating links, and thereby reduce long haul effects.

What follows is additional detail regarding link aggregation, which is one form of bonding/aggregation that may be used as part of the overall network solution and network architecture disclosed in this disclosure.

In one aspect of an embodiment, the system, method and network architecture may be implemented such that the aggregated/bonded network connections described are implemented using the link aggregation technology described in U.S. Pat. No. 8,155,158. What follows is further discussion of possible embodiments of the CPE and the server/concentrator (or concentrator) components previously described, emphasizing their creation and management of the bonded/aggregated connections between them, which in the network configuration of an embodiment form a part of the overall network overlay that incorporates the one or more portions that are carried over the network backbone.

Diverse network connections may be aggregated into virtual (logical) connections that provide higher throughput as well as independence of the network characteristics of the constituent (physical) network. Aggregation may be performed to a given CPE.

For instance, in one example of the implementation of an embodiment a Metro Ethernet 10 Mbps (E10) link and a T1 (DS1) link are aggregated as described below, in order to provide higher fault tolerance and improved access speeds. The aggregation of diverse carriers in accordance may extend to any broadband network connection including Digital Subscriber Line (DSL) communications links, Data over Cable Service Interface Specification (DOCSIS), Integrated Services Digital Network, Multi protocol Label Switching, Asynchronous Transfer Mode (ATM), and Ethernet, etc. The network connections may also include a WAN.

According to one aspect of an embodiment, an apparatus is provided for managing transfer of communication traffic over diverse network connections aggregated into a single autonomous connection, independent of the various underlying network connections. The apparatus may include a network aggregation device and an aggregation engine. The network aggregation device may be adapted to configure a plurality of network connections, which transfers communication traffic between a further network connection and the plurality of network connections, as an aggregated group for providing a transfer rate on the further communication link, and to allocate to the aggregate group a rate of transfer equal to the total available transfer rate of the underlying networks. The aggregation engine may be adapted to manage the distribution of communication traffic received both to and from a plurality of network connections, establishing newly formed aggregated network connections. The aggregation engine may be implemented in software for execution by a processor, or in hardware, or combination of both hardware and software.

In accordance with this aspect of an embodiment, a plurality of diverse network connections may be aggregated to create an aggregated network connection. The diversity of the network connections may be a result of diversity in provider networks due to the usage of different equipment vendors, network architectures/topologies, internal routing protocols, transmission media and even routing policies. These diversities may lead to different network connections with different latencies and/or jitter on the network connection. Also, variation within transmission paths in a single provider network may lead to latency and/or jitter variations within a network connection.

Latency and jitter typically affect all data communication across the network connection. Latency is the round-trip time for a transmission occurring end-to-end on a network connection. Jitter is the variance in latency on a network connection for the same data flow. High latency and jitter typically have a direct and significant impact on application performance and bandwidth. Applications such as VOIP, and video delivery are typically highly sensitive to jitter and latency increases and can degrade as they increase.

Transparent aggregation of a plurality of network connections in an aggregated network connection requires the management of data transmitted over the aggregated connection by the aggregation engine and received from the aggregation traffic termination engine. In one aspect of an embodiment, transparent aggregation does not require any configuration by a network provider. The aggregation engine and the aggregation traffic termination engine may manage data transmission such that the variable path speeds and latencies on the plurality of network connections do not affect the application data transmitted over the aggregated network connection. The network aggregation engine and the aggregation traffic termination engine may handle sequencing and segmentation of the data transmitted through the aggregated connection to transparently deliver application data through the aggregated connection with minimal possible delay while ensuring the ordered delivery of application data.

In one aspect of an embodiment, the network aggregation engine provides a newly aggregated network connection with a capacity equal to the sum of the configured maximum throughput of the network connections.

The aggregation engine and an aggregation traffic termination engine (further explained below) handle the segmentation of packets as required in confirmation with architectural specifications such as Maximum Segment Size (MSS) and Maximum Transmission Unit of the underlying network connections. The network aggregation device is operable to handle assignment of sequence identifiers to packets transmitted through the aggregated network connection for the purpose of maintaining the ordering of transmitted data units over the aggregated network connection.

In a further aspect of an embodiment, the network connection device includes or is linked to a connection termination device, and a plurality of fixed or hot swappable transceivers for transmitting communication traffic on respective sets of network connections, for the purpose of configuring a plurality of network connections as an aggregated connection or the management of multiple aggregated network connections and providing access to the aggregated network connection for any network communications traversing the device.

In the present specification, routing protocols or route selection mechanisms described are intended only to provide an example but not to limit the scope of the disclosure in any manner.

FIG. 3 is a block diagram of a communication device incorporating a particular embodiment, demonstrating the device acting as a client.

As shown in FIG. 3, the network element/network aggregation device (also referred to in this disclosure simply as the “device” or the “network aggregation device”) 23 includes (in this particular embodiment shown for illustration) a network connection termination module 25 that includes representative transceiver interfaces 14, 15 and 16. Each transceiver interface 14, 15 and 16 represents an interface to a physical communication medium through which communications may be established to network connections.

A possible implementation of the network aggregation device may use a single or multiple chassis with slots for multiple network connection termination modules and multiple network aggregation engine modules. The multiple network connection termination modules may be grouped by protocol specific or medium specific transceiver/interfaces.

The network aggregation engine 11 may handle the configuration of the network aggregation device and all related interactions with external inputs. A device configuration store 24 may provide persistent data storage for device configuration information such as a network aggregation policy.

The network aggregation engine 11 may handle queries from external sources, such as configuration parameters a network management protocol such as Simple Network Management Protocol, for example. The interface 10 may be a protocol agent and may provide for communication with a Network Management System (NMS) or operator system for configuration of the aggregation engine by the definition of an aggregation policy. Control and management information may be transferred between the network aggregation device 23 and the NMS or operator system through the interface 10 via any available or specifically designated network connection 19, 20, 21 and 17 through any transceiver interface 14, 15 and 16.

In accordance with an aspect of an embodiment, multiple network connections may be combined to form an aggregated network connection 22, as disclosed in further detail herein. Each individual network connection may be configured with a maximum communication traffic rate, which could be expressed as a bit rate in bits per second.

The network aggregation engine 11 may be implemented in software for execution by a processor in the network aggregation device 23, or in hardware such as by means of a Field Programmable Gate Array (FPGA) or other integrated circuit, or some combination thereof. The network aggregation engine 11 may be implemented in a distributed manner by distributing aggregation engine intelligence to the network connection termination module 25, in a manner that is known.

The network aggregation engine 11 may receive traffic from client network connection device 18 through a network connection 17 provided through a transceiver interface 16. The client network connection device 18 may be any device including, without limitation, a router, switch, or media converter that is capable of providing termination for a single or multiple client nodes, where nodes are any devices capable of connecting to a network irrespective of protocol or interface specificity. In various embodiments, traffic may be received over multiple network connections through a single or multiple transceiver interfaces. The network aggregation engine 11 may accept all traffic from the client network connection, may provide encapsulation and segmentation services for the traffic for transmission through the aggregated network connection 22, and may transmit it over any of the network connections 19, 20 and 21 through any of the transceiver interfaces 14, 15 and 16. The network aggregation engine 11 may handle segmentation in a manner that avoids the fragmentation of aggregated communication traffic received through the client network connection device 18, when transmission occurs over the aggregated network connection 22 through any of the network connections 19, 20 and 21, by ensuring that the length of a packet/frame transmitted over any of the network connections 19, 20 and 21 is less than or equal to the configured or detected frame length for the respective connections in the aggregated network connection 22.

The network aggregation engine 11 may poll the state of network connections 19, 20 and 21, for example as per configured intervals stored in the device configuration store 24, to ensure that all network connections configured in an aggregated group are within configured acceptable tolerances. If a network connection 19, 20, and 21 exceeds acceptable tolerance values for any of the polled parameters, the network aggregation engine 11 may remove the network connection 19, 20, and 21 from within the aggregated network connection 22 without removing it from the polled network connections list. By leaving the removed network connection 19, 20, and 21 in the polled network connection list, the network aggregation engine 11 may aggregate the network connection into the aggregated network connection 22 once it has come back within acceptable tolerance values. This may ensure that a network connection may change states between residing in an aggregated network connection 22 or not, without the intervention of an external system or input. The network aggregation engine 11 may handle notifications to all end points configured within the device configuration store 24 with internal events such as changes in network connection state, threshold violations on configured thresholds for any number of configurable variables for any object within or connected to the network aggregation device 23. The network aggregation engine 12 may also handle events such as changes in the state of a network connection 19, 20, and 21 included in the aggregated connection, changes in latency of a network connection included in the aggregated network connection 22, scheduling changes, event logging, and other events.

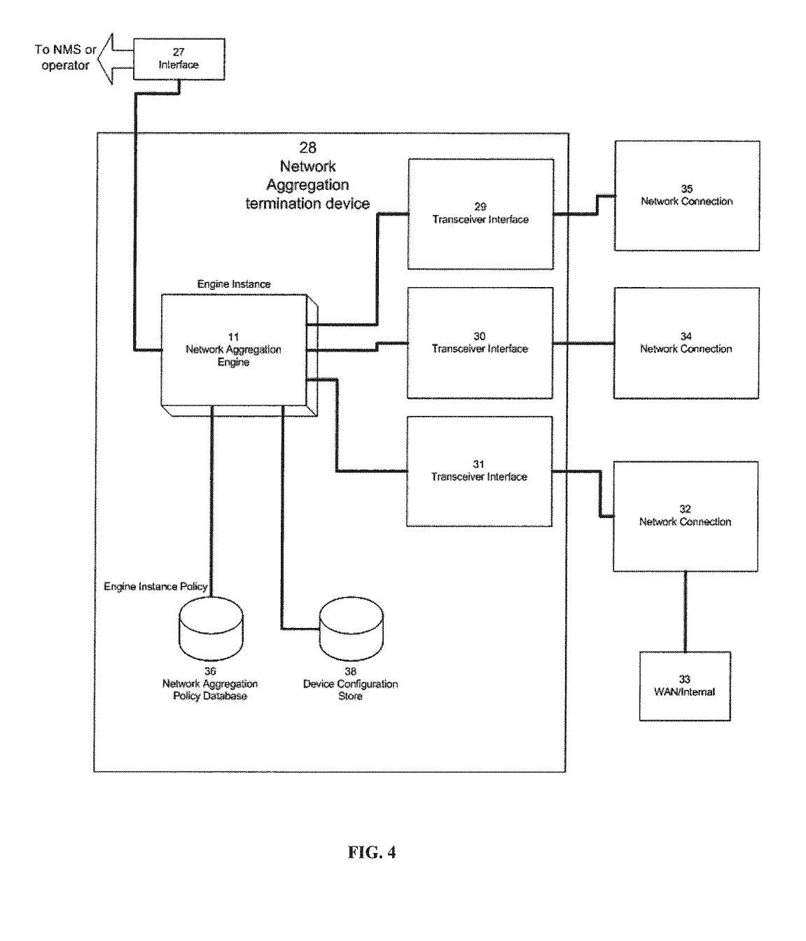

FIG. 4 is a block diagram of a communication device incorporating a particular embodiment, demonstrating the device acting as a server/concentrator.

The network aggregation engine 11 may provide access to a network aggregation policy database 36 which stores configuration information related to the various aggregated network connections that terminate on the aggregated network connection device 28. The network aggregation termination device 28 may be implemented in such a manner that each aggregated network connection defined in the network aggregation policy database 36 is handled by its own virtual instance, the use of which enables termination of each aggregated network connection from multiple customer premises equipment (CPE).

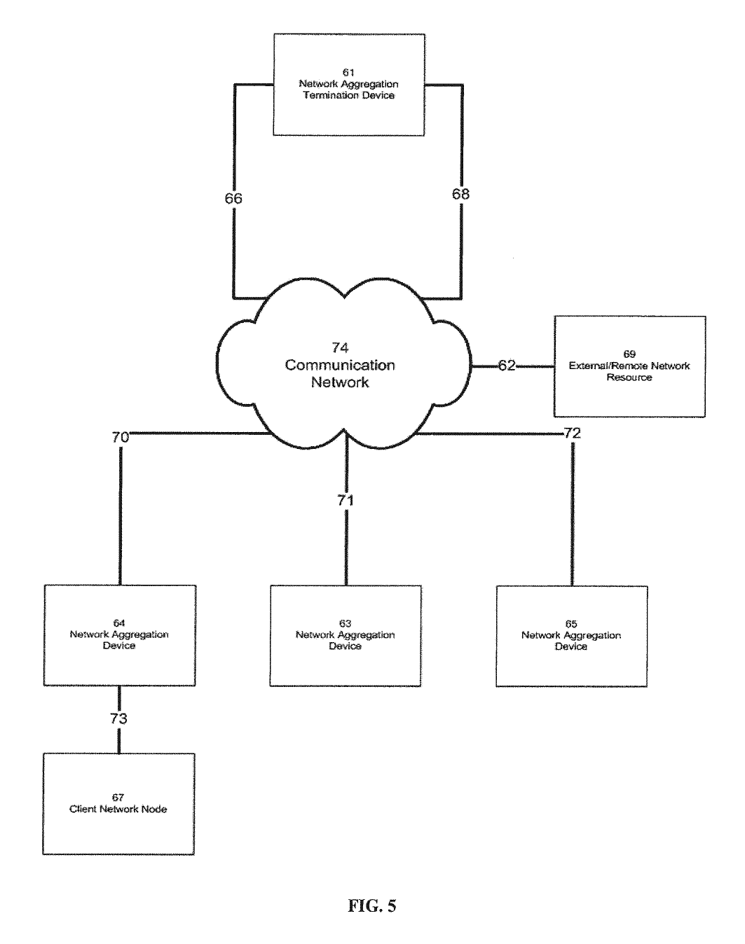

FIG. 5 is a block diagram of a communication network incorporating a particular embodiment, demonstrating the function of the device acting as a client/CPE and server/concentrator.

In accordance with a particular embodiment, aggregated network connections 70, 71 and 72 may be built by network aggregation devices 63, 64 and 65, which terminate to a single aggregated network connection termination device 61 through network connections 66 and 68 as their endpoint. The aggregated network connection termination device 61 may access external communications networks through network connections 66 and 68 to access external/remote network resource 69. Access to external communications networks may be provided by the aggregated network connection termination device 61 by using either network connection 66 or 68 through the use of a routing protocol, such as Border Gateway Protocol (BGP), Open Shortest Path (OSPF), or through the use of simpler mechanisms such as load sharing over multiple static routes within the communication network 74 that acts as the valid next-hop for the aggregated network connection termination device 61.

Aggregated network connections 70, 71 and 72 may provide access to client network nodes 67 connected to the network aggregation devices 63, 64 and 65 through the aggregated network connections 70, 71 and 72 to communications networks 74 accessible by the aggregated network connection termination device 61.

A client network node 67 may request data provided by an external/remote network resource 69 accessible through a communication network 74. This request for the external/remote network resource may be routed over the network connection 73 providing access from the client network node 67 over the aggregated network connection 70 to its end point which is the aggregated network connection termination device 61. This may be done through the communication network 74 through the network connection 66 into the aggregated network connection termination device 61. Any data sent by the external/remote network resource 69 may be routed back through the aggregated network connection termination device.

A particular embodiment may use the Internet as the communication network 74 referenced in FIG. 5. However, the communication network 74 may alternatively be built by multiple sub-networks created through the use of multiple network aggregation devices 63, 64 and 65 with aggregated network connection termination device 61 end points through multiple network connections 66 and 68.

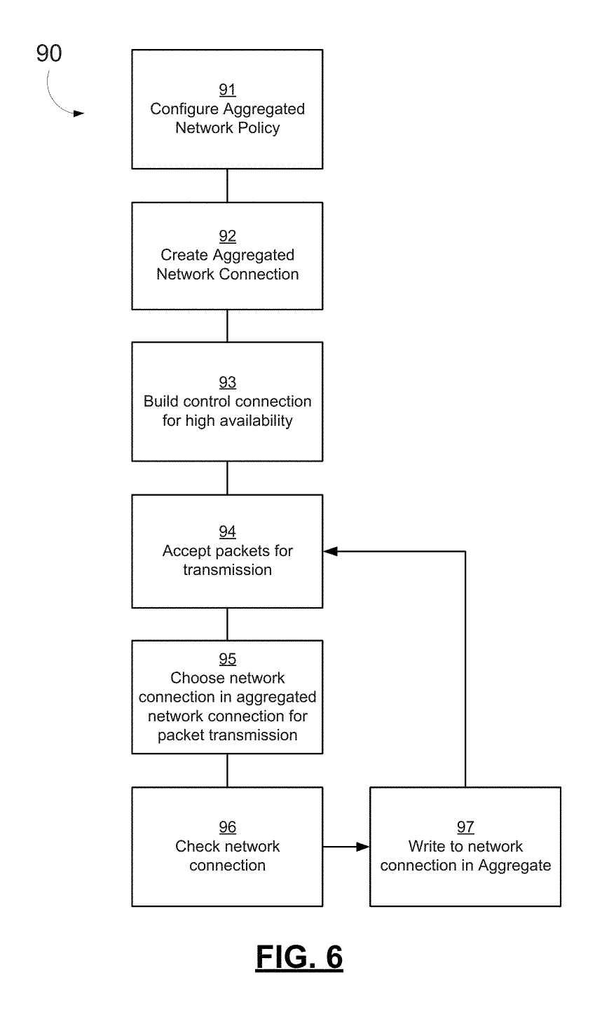

A further aspect of an embodiment relates to the provisioning of high availability over the aggregated network connection by the network aggregation engine 11. FIG. 6 illustrates a method of providing redundancy and increased throughput through a plurality of network connections in an aggregated network connection. The method 90 may begin with a step of configuring a plurality of network connections 91 through the creation of a network aggregation policy to form 92 the aggregated network connection. The aggregated network connection may be initialized as per the network aggregation policy. Control connections may be created 93 for the plurality of network connections configured as part of the aggregated connection to allow the aggregation engine 11 to manage the membership of a network connection within the aggregated connection. The network aggregation engine 11 may accept packets for transmission 94 over the aggregated network connection 22. The network aggregation engine 11 may choose a network connection 95 among the group of network connections configured 91 in the aggregate in the stored aggregation policy for transmission of the current packet being transmitted. The choice of network connection for transmission of the current packet may be specified within the aggregation policy and may take into account data provided by the control connection built at 94.

According to one embodiment, a non-responsive network connection may be easily detected when using latency and packet loss as a measure. The mechanism for detecting 96 and adapting to 97 the network connection change within an aggregated network connection may be implemented within the data transmission routine in the aggregation engine 11 or as a separate process in parallel to the transmission routine in the aggregation engine 11 to allow for further flexibility in provisioning redundancy within the aggregated network connection.

Since this may occur on a per packet basis as opposed to on a per stream basis, a single non-responsive network connection may not affect the aggregated network connection and may allow data transmission to continue regardless of the individual states of network connections so long as a single network connection within the aggregated network connection is available for data transmission.

### Example in Operation

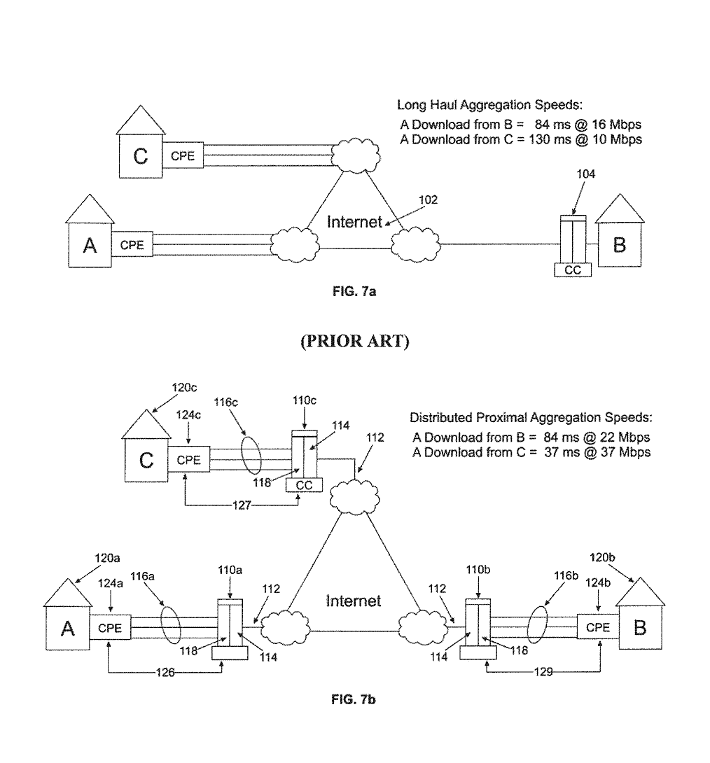

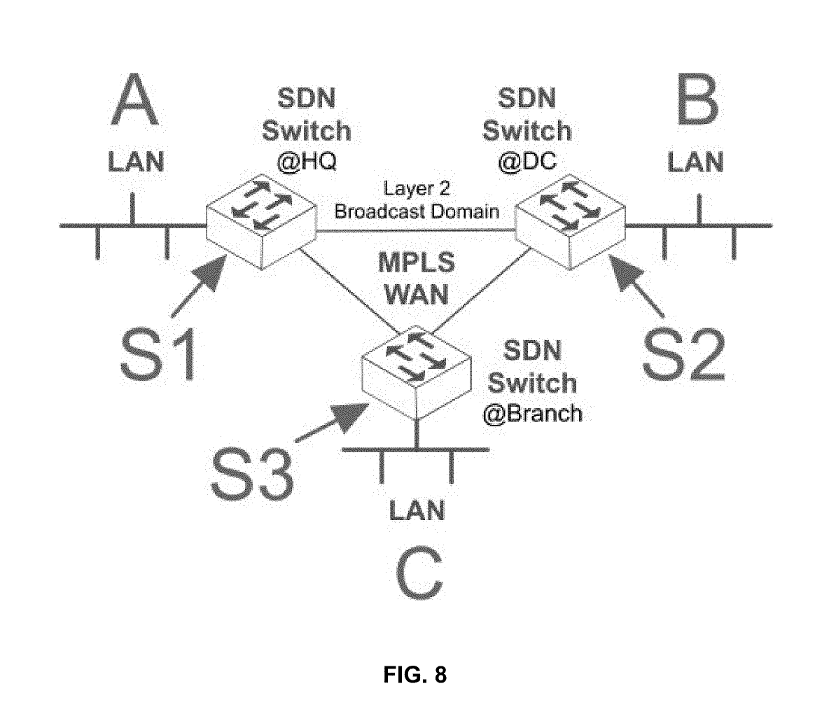

In one possible implementation of an embodiment, 3 locations are provided namely Site A, Site B, and Site C, and Site D. FIGS. 7a and 7b illustrate network performance as discussed herein. FIG. 7a illustrates performance with long haul effects. FIG. 7b illustrates performance with reduction of long haul effects, based on the embodiment in network conditions otherwise similar to those on which FIG. 7a is based.

FIG. 7b shows an improvement in performance over FIG. 7a, based on reduction of long haul effects in relatively long distance network communications are implemented using the network architecture.

The present disclosure therefore provides improved network performance relative to speed. A skilled reader will appreciate that the improvement in performance shown in significant. Other aspects of network performance are also improved, based on the present disclosure, for example latency.

### Software-Defined Quantum Communication

Quantum key distribution (QKD) can encrypt communication between a sender and a receiver by creating a key and sending weak optical pulses having less than one photon, on average over a quantum channel. Once a key is successfully created between the sender and the receiver, the devices can communicate over a public channel by using the exchanged key to encrypt messages using secure one-time pad encryption or some other key encryption algorithm. For QKD technology, keys of a suitable length (e.g., 256 bits) can be generated at a rate of about 1-100 per second, depending on the separation between the sender and the receiver (e.g., the length of the optical fiber length connecting the two).

Entangled photon integrity can only reach 50 KM on a passive fiber network. This is a hard limit because the optical signal cannot be repeated, as the repeating action requires a viewing/measuring of the photon which changes the quantum state and triggers an intrusion. This intrusion causes a rekey and a new entangled photon pair to be created and producing a new quantum key for distribution, thereby facilitating the detection of an intruder.

In some embodiments, entangled photons may be used to create impenetrable keys for encrypting data. If anyone tries to observe the entangled photons the quantum state changes and this can be detected causing the creation of a new key.

For example, such QKD technology may be used as part of Underlay Transport Encryption Process in an IPSec implementation.

Referring now to FIG. 8, in which a WAN network diagram is shown. This WAN may be a basic Software Defined Network (SDN) between switches. As can be seen, within the same broadcast domain (layer 2), all SDN switches are visible to each other, each switch can create Virtual LANs to other switches to form multi-tenant WANs. For example, LANs A, B, and C may form a WAN, which may be a WAN created between switches. From LAN to LAN, it's a full mesh network with Headquarter (HQ), DC and Branches. The mesh network allows site to site communications.

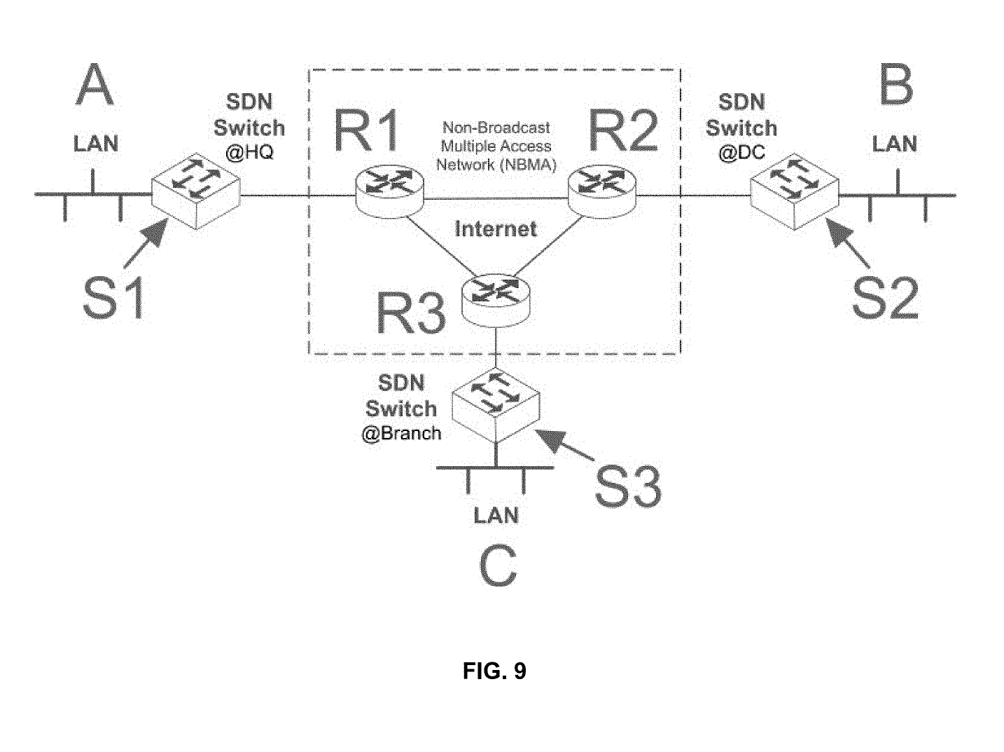

Referring now to FIG. 9, there is shown a diagram of SDN components between switches. As shown, the Internet is not multicast, so not all routers and switches along the network path are controlled. There is no SDN between switches, which means routers must be included for the SDN feature. This is a network provided by a third party routers or carriers and service provider that may not be ready to open up core network for outside control.

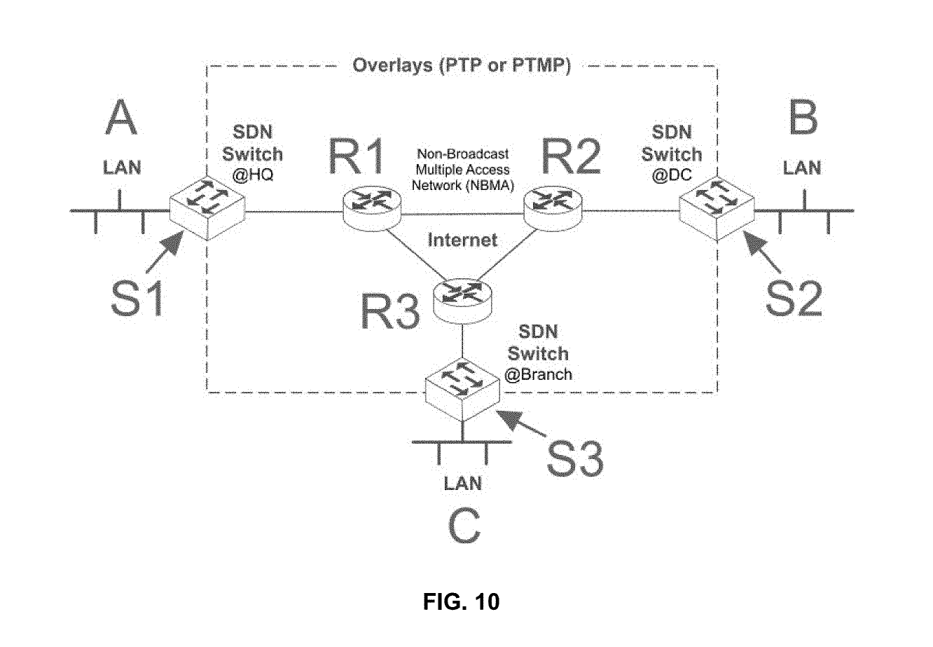

Referring now to FIG. 10, there is shown a diagram of SDN components between switches with overlays, in accordance with some embodiments. As can be seen, this network uses unicast for Internet, so that overlays may be formed between switches with tunneling protocols such as GRE, VxLAN and so on. There are SDN between switches, which means 3^{rd} party routers or carrier and service providers needs not be involved. In addition, Each switch can create Virtual LANs to other switches to form multi-tenant WANs.

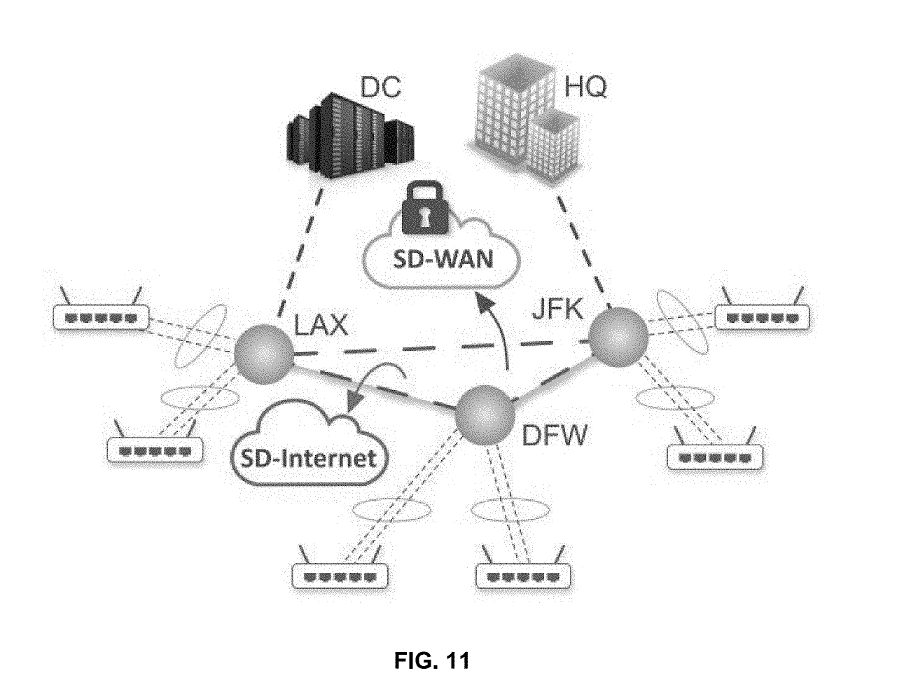

Referring now to FIG. 11, there is shown a diagram of a SD-WAN with overlay networking, in accordance with some embodiments. As can be seen, there is at least one control plane with full mesh hubs. Multi-tenant controllers may be implemented at one or more Point-of-Presence (POP). In this case, customer route domains are protected and overlapping submits are supported. There may also be at least one data plane with hub to spokes. There may be a CPE to Controller at Home-POP, with proximal aggregation of network links. There may also be bridges to control planes at one or more POPs. Full mesh may exist between LAN to LAN, between HQ, DC and Branches with site to site communications.

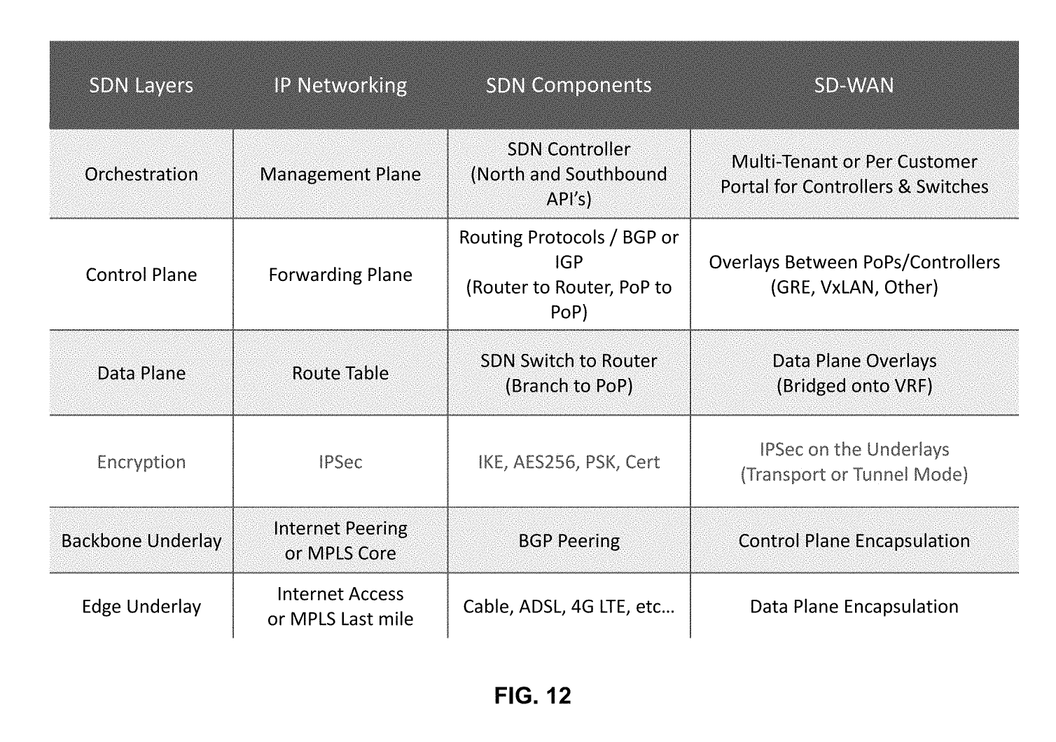

Referring now to FIG. 12, there is shown an infrastructure table for SD-WAN secure overlay framework in accordance with some embodiments. As can be seen, overlays can be used to bridge data centers across third party infrastructures. Virtual network paths may be created, forming SD-WAN or extending WAN network reach. GRE/NVGRE and VxLAN Can be orchestrated by SDN Controllers. In some cases, encryption may be moved from physical to transport when supporting overlays.

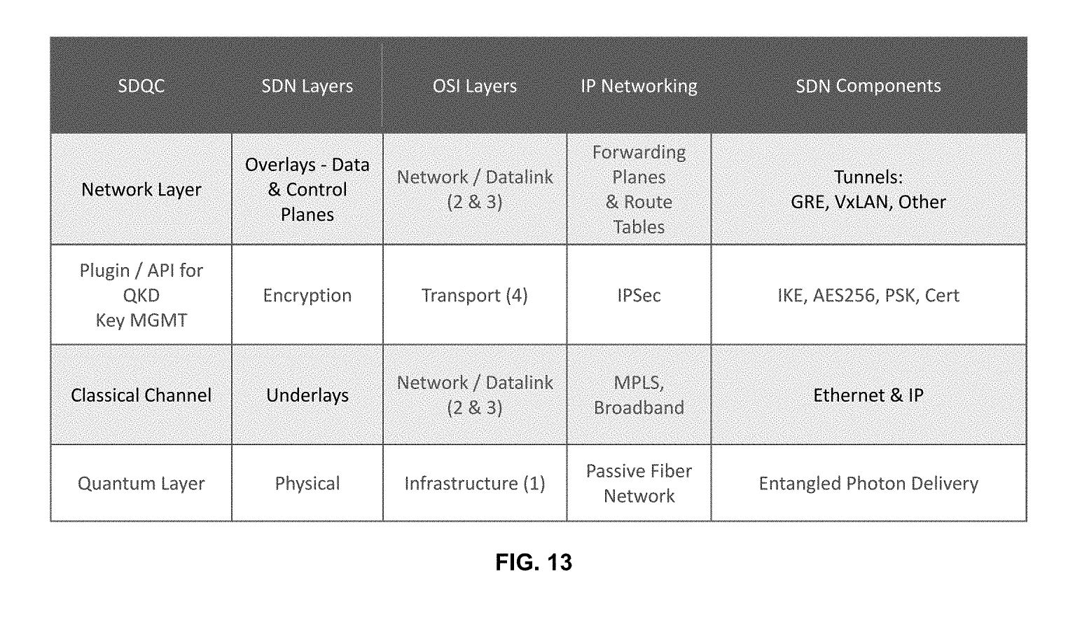

FIG. 13 shows a framework for securing network overlays with Quantum Key Distribution (QKD), in accordance with some embodiments. For example, QKD may be used to secure overlay networks or adapted to existing IPSec products such as IPSec open source products.

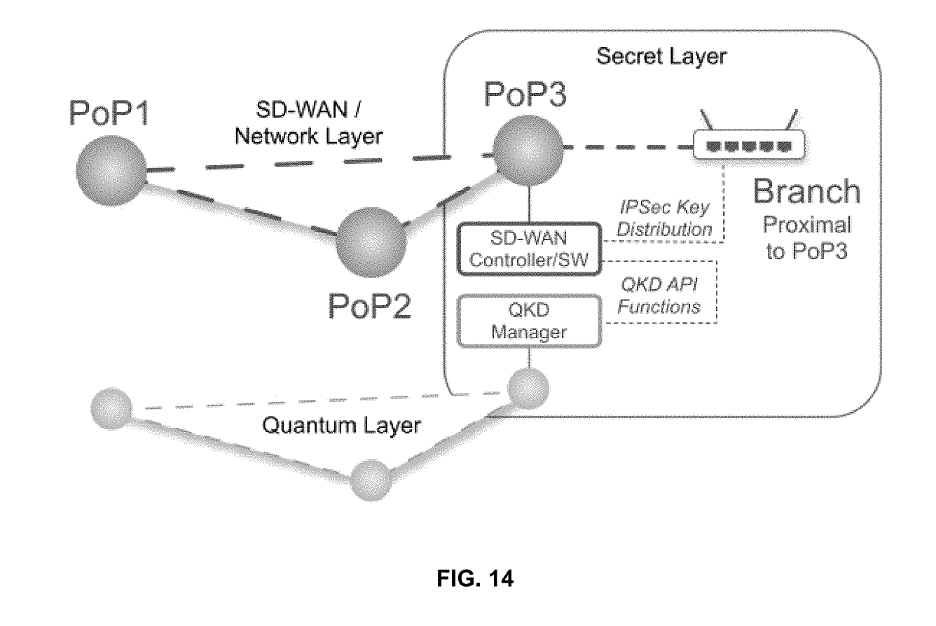

FIG. 14 shows an example embodiment of QKD implementation for SD-WAN with overlay, in which a quantum layer key is extended to the Branch. As shown, there may be passive fiber network between PoPs, and the quantum layer may distribute entanglement over multiple channels for multiple tenants. Low bandwidth optical network may be used for key integrity. On a per customer basis, SD-WAN controller may use QK for itself and proximal branch sites. In addition, there may be a secret quantum layer over classic network. As shown in FIG. 14, a QKD Manager may be provided for SW or HW (Virtualized on SW), QKD API functions may be provided for SDN Controllers, SDN controller may use and distribute keys at a distance expanding quantum layer reach, and distance is within IPSec rekey interval.

There may be some constraints for the quantum layer. For example, there may be a maximum distance between PoPs when a quantum layer is added. In some embodiments, free-space or wireless optical options may be used between PoPs for greater reach to deal with the maximum distance between PoPs.

In some embodiments, a range of APIs or add-ons may be used for QKD. For example, strongSwan may be a used for IPSec, Linux and FreeBSD IPSec key exchange may be used to code for QKD, and API for Intel DPDK crypto key exchange process may be used as well.

In some embodiments, overlay networks may be secured using Quantum Key Distribution (QKD) techniques for the purpose of expanding the OpenFlow API to support QC for QKD.

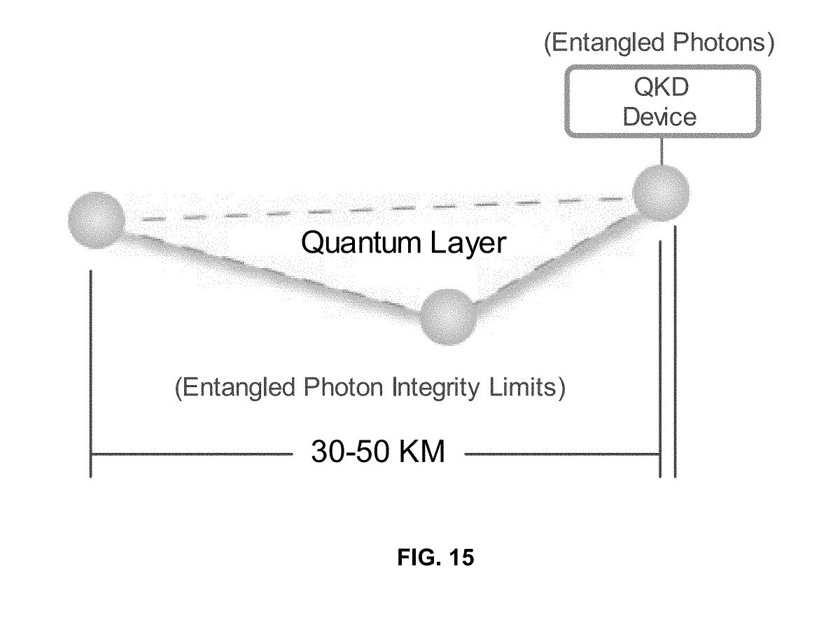

Referring now to FIG. 15, there is shown a diagram of quantum layer and QKD device. Embodiments extend the reach of the Quantum Layer Key with a Centralized Orchestrator that will securely distribute Quantum Keys (QK) to a dependent chain of devices. The dependent chain of devices (DCDs) can be groups of CPE's and or Controllers that use per customer Keys for their encryption in the Underlay to protect the Overlay that forms a customer protected route domain.

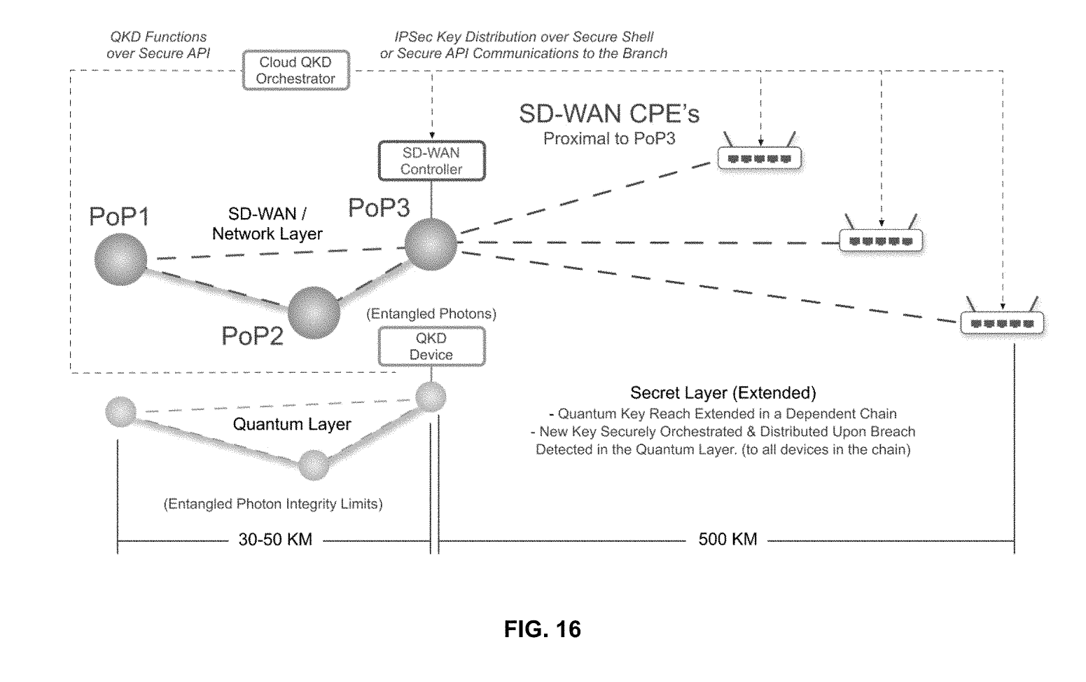

Referring now to FIG. 16, there is shown a network diagram implementing a quantum layer and QKD. As shown, an extended secret layer allows an quantum key to extend its reach in a dependent chain, and new key is securely orchestrated and distributed upon breach detected in the quantum layer to all devices in the chain.

In one embodiment, the system can extend the reach of the above using network overlays to distribute the Key. Although the entangled photon anomaly along the overlay no longer protects the overlay, the overlay itself is protected in a chain of overlays by the last entangled photon integrity point in the path where the overlays originated. This key in the overlays may be protected and the same key may be used to create the overlays themselves through a cloud orchestration process which has its own encryption for key delivery. Should any snooping of the photons take place within the 50 KM ring between entangled sources, the key will change and the entire VWAN extended chain will rekey and get re-orchestrated.

This solution provides enhanced security for IPSec and other encryption dependent applications.

1. A network system for improving network communication performance between a first client site and a second client site, comprising:
(i) at least one client site network component that is implemented at the first client site, the client site network component bonding or aggregating one or more diverse network connections so as to configure a bonded/aggregated connection that has increased throughput; and
(ii) at least one network server component, configured to interoperate with the client site network component, the network server component including a server/concentrator that is implemented at an access point to a high performing network;
wherein the client site network component and the network server component are configured to interoperate so as to create and maintain a network overlay for managing network communications between the first client site and the access point, wherein between the client site network component and the network server component data traffic is carried over the bonded/aggregated connection and between the access point and the second client site the network server component automatically terminates the bonded/aggregated connection and passes the data traffic to a network backbone of the high performing network, while maintaining management of data traffic so as to provide a managed network path that incorporates both at least the bonded/aggregated connection and at least one network path carried over the high performing network, and wherein the system uses quantum key distribution to encrypt the managed network path.

2. The system of claim 1, further comprising a quantum layer configured to distribute at least one quantum key to encrypt the managed network path.

3. The system of claim 2 wherein the quantum layer is implemented at a physical network layer.

4. The system of claim 2 wherein the quantum layer is implemented using entangled photon delivery.

5. The system of claim 2 wherein the quantum layer is implemented using a passive fiber network.

6. The system of claim 2 wherein the quantum layer implements entangled photon integrity limits for delivery of entangled photon from a quantum key distribution device.

7. The system of claim 2, further comprising a quantum key distribution manager device operable to detect a security breach in the quantum layer, and upon the detection of the security breach, operable to provide and distribute a new secure key.

8. The system of claim 2, further comprising a Centralized Orchestrator configured to securely distribute Quantum Keys to a dependent chain of devices.

9. The system of claim 8 wherein the dependent chain of devices can be groups of client site network components and network server components configured to use per customer keys for encryption in an underlay network to protect the network overlay to form a customer protected route domain.

10. The system of claim 1 wherein quantum key distribution can encrypt communication between a sender device and a receiver device by creating a key and sending weak optical pulses over a quantum channel, wherein the key enables the devices to communicate over a public channel by using the exchanged key to encrypt messages.

11. A network system for improving network communication performance between a first client site and a second client site, comprising:
(i) at least one client site network component that is implemented at the first client site, the client site network component bonding or aggregating one or more diverse network connections so as to configure a bonded/aggregated connection that has increased throughput; and
(ii) at least one network server component, configured to interoperate with the client site network component, the network server component including a server/concentrator that is implemented at an access point to a high performing network;
wherein between the client site network component and the network server component data traffic is carried over the bonded/aggregated connection and between the access point and the second client site the network server component automatically terminates the bonded/aggregated connection and passes the data traffic to a network backbone of the high performing network, and wherein the system uses quantum key distribution to encrypt the managed network path.

12. The system of claim 11, further comprising a quantum layer configured to distribute at least one quantum key to encrypt the managed network path.

13. The system of claim 12 wherein the quantum layer is implemented at a physical network layer.

14. The system of claim 12 wherein the quantum layer is implemented using entangled photon delivery.

15. The system of claim 12 wherein the quantum layer is implemented using a passive fiber network.

16. The system of claim 12 wherein the quantum layer implements entangled photon integrity limits for delivery of entangled photon from a quantum key distribution device.

17. The system of claim 12 further comprising a quantum key distribution manager device operable to detect a security breach in the quantum layer, and upon the detection of the security breach, operable to provide and distribute a new secure key.

18. The system of claim 12 further comprising a Centralized Orchestrator configured to securely distribute Quantum Keys to a dependent chain of devices.

19. The system of claim 18 wherein the dependent chain of devices can be groups of client site network components and network server components configured to use per customer keys for encryption in an underlay network to protect the network overlay to form a customer protected route domain.

20. The system of claim 11 wherein quantum key distribution can encrypt communication between a sender device and a receiver device by creating a key and sending weak optical pulses over a quantum channel, wherein the key enables the devices to communicate over a public channel by using the exchanged key to encrypt messages.
